(19) United States
(12) Patent Application Publication
(10) Pub. No.: US 2005/0030847 A1
(43) Pub. Date: Feb. 10, 2005

(54) Method for correcting a position of an optical pickup before track following

(75) Inventors: Jen-Yu Hsu, Taipei (TW); Hsiang-Yi Fu, Taipei (TW); Tun-Chieh Lee, Taipei (TW); Fu-Hsiang Chen, Taipei (TW); Yao-Chou Tsai, Taipei (TW)

Correspondence Address: BACON & THOMAS, PLLC, 625 SLATERS LANE, FOURTH FLOOR, ALEXANDRIA, VA, 22314, US

(73) Assignee: LITE-ON IT CORPORATION, Taipei (TW)

(21) Appl. No.: 10/912,112

(22) Filed: Aug. 6, 2004

(30) Foreign Application Priority Data
Aug. 8, 2003 (TW) 92121927

(51) Int. Cl. G11B 7/085

(52) U.S. Cl. 369/44.28; 369/44.29

(57) ABSTRACT

A method for correcting a position of an optical pickup before track following is disclosed. The actual position of the optical pickup before seeking is detected. Then, a sled motor control signal is provided to compensate for the force of the sled seeking such that the optical pickup is at a center of a movable range after seeking.

This application claims the benefit of Taiwan application Serial No. 092121927, filed Aug. 8, 2003, the subject matter of which is incorporated herein by reference.

### BACKGROUND OF THE INVENTION

1. Field of the Invention

The invention relates in general to a method for correcting a position of an optical pickup before track following in an optical disk drive, and more particularly to a method capable of positioning the optical pickup at a center of its movable range before track following in the optical disk drive.

2. Description of the Related Art

A servo in an optical disk drive functions to control an optical pickup to correctly read the data recorded on the optical disk. When a host outputs a read or write command, the seeking servo will first perform the seeking operation. That is, the seeking servo moves the optical pickup to a target track identified by the servo. Next, the track following servo performs the track on operation of the optical pickup, and enters the track following operation after the tracking state is ensured. At this time, the track following servo adjusts the optical pickup to the to-be-read or to-be-written position, and then the read or write operation is enabled. How to adjust the position of the optical pickup during the track following in the optical disk drive will be described in the following.

FIG. 1 is a schematic illustration showing an optical pickup module. Referring to FIG. 1, the optical pickup module 1 includes an optical pickup 3, a spring 5, a sled 7, and a laser diode (not shown), etc. During the track following, the track following servo only slightly adjusts the position of the optical pickup 3. The position adjustment is completed by the spring 5. The spring 5 slightly moves the optical pickup 3 according to the force provided by the track following servo, as shown in FIGS. 1B and 1C. The track following servo detects the to-be-read/written position, and then exerts force on the spring 5 to pull the optical pickup 3 to the to-be-read/written position. Then, the optical disk drive performs the read or write operation.

At the beginning of the read or write operation, the optical pickup 3 is located at the center of the sled 7, as shown in FIG. 1A. The optical pickup is shifted in direction 2 to a position, as shown in FIG. 1B after the data of several hundreds of tracks has been written (read). However, the movable range of the optical pickup 3 in the sled 7 is limited. When the optical pickup 3 is within the movable range in the sled 7, the laser light reflected from the optical disk 12 transmit along the path 11, thereafter pass through the objective lens 13 and reflect by the semi-transparent mirror 10 to reach the detector 8 in FIG. 2. If the optical pickup 3 exceeds the movable range in the sled 7, the laser light thereof reaches the detector along the path 9 of FIG. 2. At this time, the quality of the detected laser light reflected from the optical disk is not the optimum, and the read or write quality thus becomes poor. Consequently, if the optical pickup 3 exceeds the movable range on the sled 7, the read/write fail will be easily caused.

In order to avoid the above-mentioned read/write fail, the track following servo utilizes a sled motor control signal (hereinafter, FMO) to adjust the position of the optical pickup 3. The FMO is the voltage for forcing the sled 7 to move in a manner that the relative position between the optical pickup 3 and the sled 7 is changed and thus the optical pickup 3 may be positioned within the movable range again.

The sled motor control signal is obtained after the low-pass filter has processed a track control output signal (hereinafter, TRO signal) during the track following. Because the TRO signal represents the magnitude and direction of the exerted force of the optical pickup 3, forcing the sled 7 according to the TRO signalmay keep the optical pickup 3 within its movable range.

As shown in FIG. 3A, the optical pickup 3 is at the center of the sled 7 and no force is applied to the optical pickup 3, so the sled motor control signal falls within the reference voltage. When the read (write) operation is started, the servo exerts force on the spring 5 to make the optical pickup 3 move in the direction 25 according to the read (write) position. Because force is applied to the optical pickup 3, the sled motor control signal also starts to apply force to the sled 7, as shown in FIG. 3B. However, the force of the sled motor control signal is not sufficient to move the sled due to the weight of the sled and the friction force. The optical pickup 3 continues to move in the direction 25 for reading (writing), and the optical pickup 3 is offset from the center of the sled 7, as shown in FIG. 3C. At this time, the optical pickup 3 approximately exceeds its movable range, and the force of the sled motor control signal is large enough to push the sled. So, force is applied to the sled, the sled is moved in the direction 25, and the optical pickup 3 again returns to the center of the sled 7, as shown in FIG. 3E. When the track following is performed, the servo uses the above-mentioned procedure to keep the optical pickup 3 always within its movable range. Consequently, the optical disk drive is free from the read/write fail.

However, when the typical optical disk drive is seeking, the above-mentioned mechanism is not enabled as the track following is. When the optical disk drive receives a seeking command outputted from the servo, it directly performs the kick sled operation no matter how the relative position between the optical pickup and the sled is. However, this operation tends to cause poor quality in read or write operations when the optical disk drive enters the track following operation.

When the relative position between the optical pickup 3 and the sled 7 is that as shown in FIG. 4A, the servo outputs a seeking command, the sled force 17 is applied to the sled 7 to make it move in the direction 15. When the optical pickup 3 reaches the target track, it will be much more deviated from the center of the sled 7, as shown in FIG. 4B. If the track following step is directly enabled at this time, a longer time is needed to adjust the position of the optical pickup 3 and the read or write quality is relatively poor. So, it is known that the prior art track following of the optical disk drive needs a more effective method for controlling the position of the optical pickup.

### SUMMARY OF THE INVENTION

It is therefore an object of the invention to provide a method for correcting a position of an optical pickup before track following so as to solve the problem of poor quality in read or write when the track following is enabled after seeking.

The invention achieves the above-identified object by providing a method for correcting a position of an optical pickup before track following. The actual position of the optical pickup before seeking is detected. Then, a sled motor control signal is provided to compensate for the sled seeking force such that the optical pickup is at a center of a movable range after seeking.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIGS. 1A to 1C show influences on a track following control output signal when relative positions between the optical pickup and the sled are different.

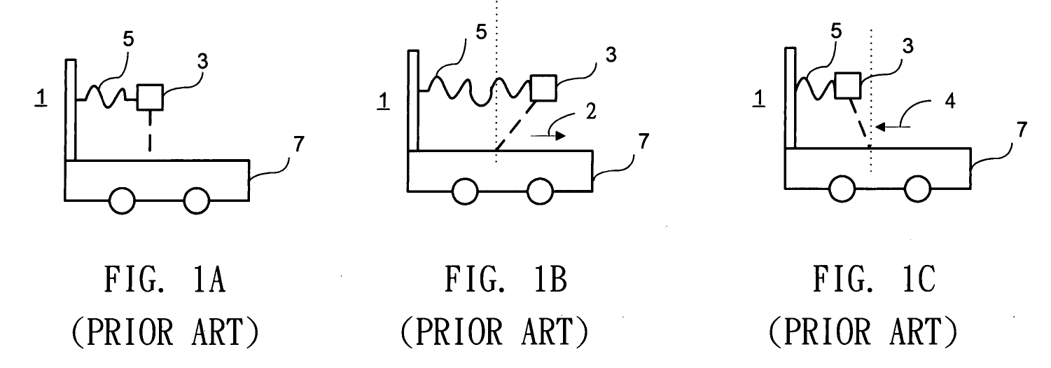

FIG. 2 shows differences of laser light paths owing to different relative positions between the optical pickup and the sled.

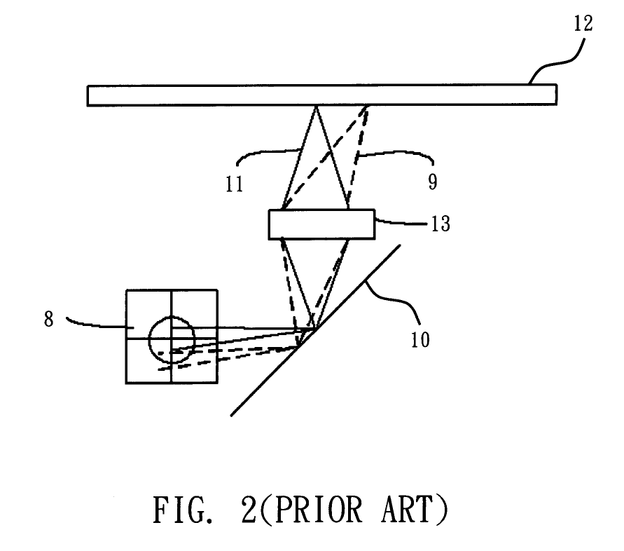

FIG. 3A to 3E are schematic illustrations showing relative positions between the optical pickup and the sled during the track following.

FIGS. 4A and 4B are schematic illustrations showing relative positions between the sled and the optical pickup before the sled force is not compensated.

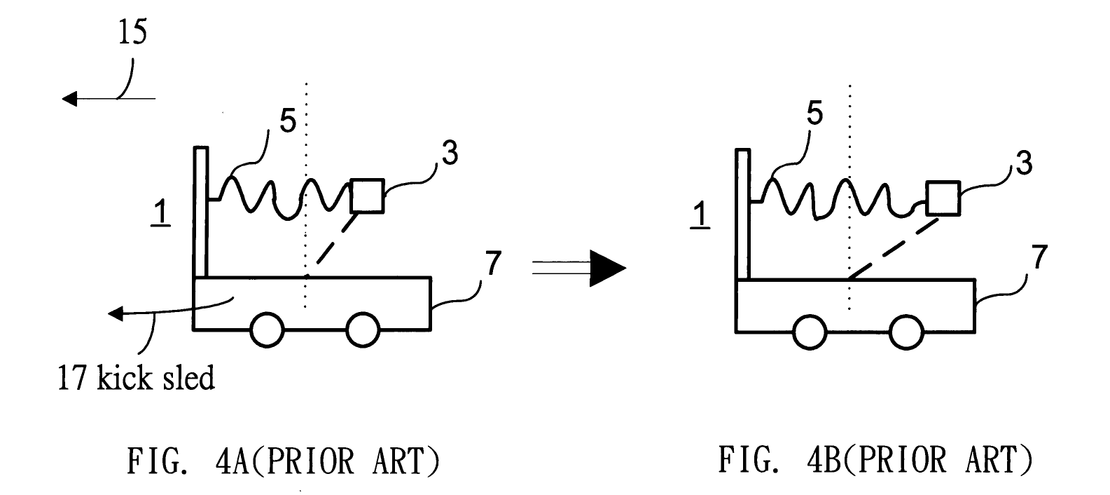

FIG. 5 is a control flow chart showing the method of the invention.

FIGS. 6A and 6B are schematic illustrations showing relative positions between the sled and the optical pickup before the sled force is compensated in the invention.

### DETAILED DESCRIPTION OF THE INVENTION

In general, the optical disk drive has no operation for correcting the optical pickup before track following. As long as the servo outputs a read or write command, the optical disk drive directly performs the seeking operation. However, when the track following is enabled immediately after the drive seeking of the optical disk, sometimes the optical pickup is not well positioned, thereby causing the poor read or write quality. In order to overcome the above-mentioned problem, the invention provides a method for correcting a position of an optical pickup before track following.

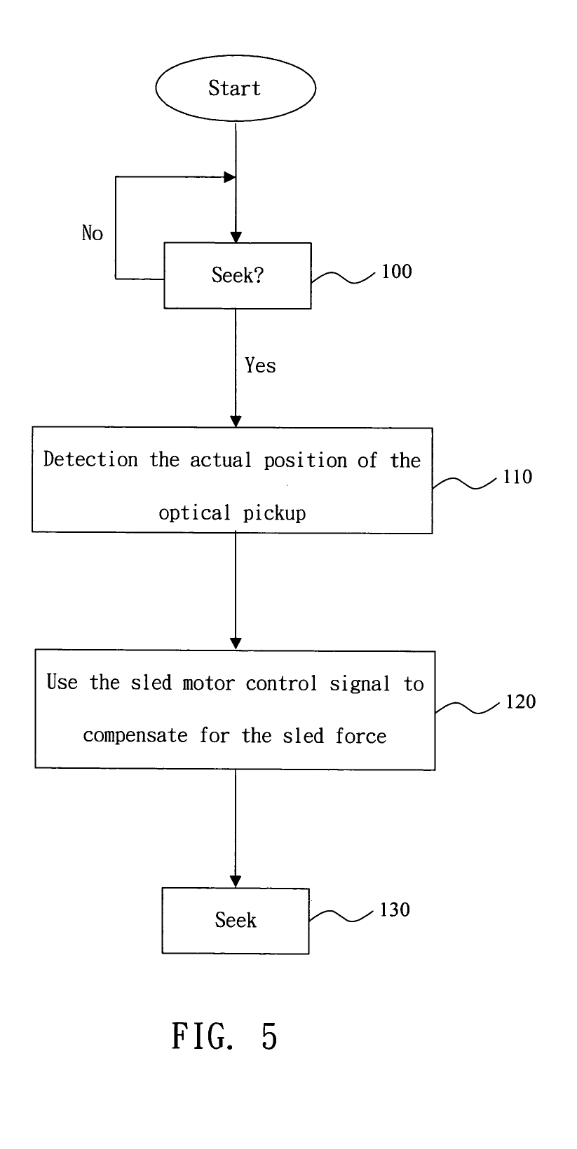

FIG. 5 is a flow chart showing the method of the invention for correcting the position of the optical pickup.

In step 100, it is detected whether or not the optical disk drive wants to perform the seeking operation. If yes, step 110 is performed; or otherwise the correction procedure is not performed.

In step 110, the actual position of the optical pickup is detected. In some optical disk drive under the track following phase, a center error signal is used to detect the position of the optical pickup. The center error signal is the position signal when the optical pickup is within the movable range. When the center error is at the zero-crossing, it represents that the optical pickup is at the center of the movable range. Thus, when the control mode of the optical pickup is switched to the track following, the center error deviates from the zero-crossing by a value, according to which the position of the optical pickup may be obtained. However, the run out phenomenon of the center error tends to be caused when the wobble structure signal on the optical disk is too strong, and the position of the optical pickup tends to be misjudged. Also, not all of the optical pickups have the center error signal, so the center error cannot inevitably represent the relative position between the optical pickup and the sled.

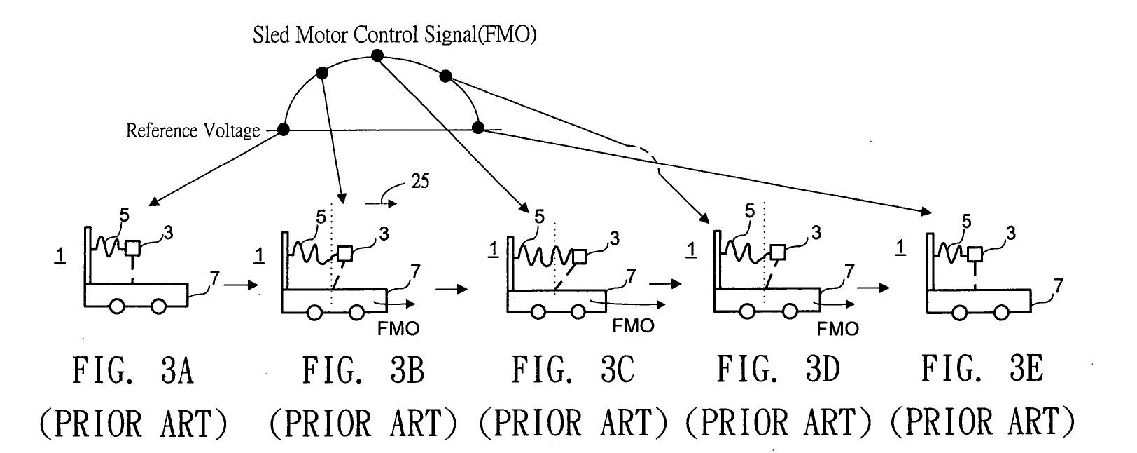

In this embodiment, the actual position of the optical pickup is detected using the sled motor control signal. As shown in FIG. 3, the sled motor control signal is a force voltage originally used to move the sled 7 such that the position of the optical pickup 3 is adjusted. However, because it represents the force exerted when the sled is seeking, the sled motor control signal falls within the reference voltage, as shown in FIG. 3A, when the optical pickup 3 is at the center of the sled 7. On the contrary, as the position of the optical pickup 3 is more offset from the center of the sled 7, the amplitude of the sled motor control signal is larger, as shown in FIG. 3C. Thus, using the sled motor control signal to detect the actual position of the optical pickup 3 is more representative and precise than the center error signal.

In step 120, the sled motor control signal is used to compensate for the sled force. The actual position of the optical pickup has been detected in step 110, so the servo makes the calculation according to the position of the optical pickup, and compensates for the force required by the sled when the seeking is performed. Then, step 130 is performed.

In step 130, the seeking process is performed.

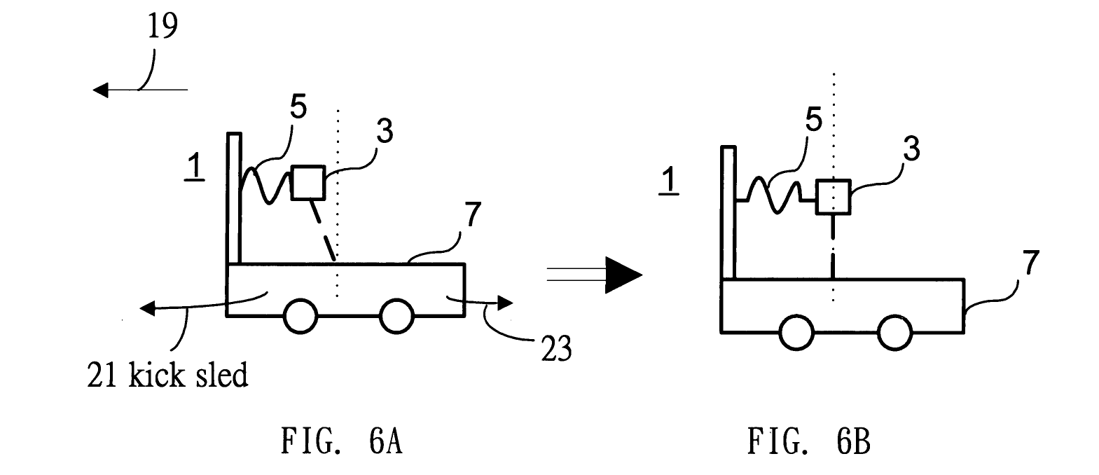

FIG. 6 is a schematic illustration showing the embodiment. When the optical disk drive outputs the read or write command, the actual position of the optical pickup 3 is calculated according to the sled motor control signal. It may be known that the optical pickup 3 is not at the center of the movable range, and there are 50 tracks of distance from the optical pickup 3 to the center of the sled 7 according to the sled motor control signal. It is assumed that the 500 tracks have to be jumped over in the direction 19 when the sled has received the command of the servo, the force 21 to be applied to the sled is compensated according to the sled motor control signal. The sled force 21 is originally planed to be applied to the sled to make the sled slide 500 tracks, but only the force for making the sled to slide 450 tracks is applied owing to the compensation. Consequently, when the sled 7 reaches the target track, the optical pickup 3 is at the center of the sled 7, as shown in FIG. 6B. So, when the track following phase is entered, the read and write quality has already reached the optimum state. Thus, the read and write quality of the optical disk drive may be effectively enhanced.

Thus, the advantage of the invention is to achieve the correction of the position of the optical pickup before track following process using the existing hardware apparatus. The position of the optical pickup after the seeking is the best state after the calculation for obtaining the force for compensation according to the sled motor control signal. Especially, when the tracking state after seeking occurs, the above-mentioned mechanism also may be used to control the optical pickup to the optimum position and then enter the track following phase. Consequently, the optical disk drive may have the better quality when the read or write operation is performed.

Another advantage of the invention is to effectively detect the position of the optical pickup. The invention utilizes the sled motor control signal to detect the position of the optical pickup in a more precise way than the prior art using the center error to detect the position of the optical pickup. Also, the invention solves the problems of incapable of detecting the position of the optical pickup when no center errors exist in some specific optical pickup. In addition, in an optical disk drive requesting for the higher read/write quality, the position of the optical pickup may be obtained and then adjusted so that better read/write quality may be obtained.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A method for correcting a position of an optical pickup before track following in an optical disk drive, comprising the steps of:
detecting an actual position of the optical pickup; and
compensating for a force to be applied to a sled during seeking according to the actual position and a sled motor control signal such that the optical pickup after the seeking is at a predetermined position.

2. The method according to claim 1, wherein the actual position of the optical pickup is detected using either the sled motor control signal or a center error.

3. The method according to claim 1, wherein the sled motor control signal is obtained during the track following after a track control output signal has passed through a low-pass filter.

4. The method according to claim 1, wherein the predetermined position is at a center of a movable range of the optical pickup on the sled.

5. The method according to claim 1, wherein the force is calculated according to the actual position and the sled motor control signal.
